(19) United States
(12) Patent Application Publication
(10) Pub. No.: US 2005/0060797 A1
(43) Pub. Date: Mar. 24, 2005

(54) Portable self-cleaning bodily waste receptacle

(76) Inventors: Wendell Gilmore, Elmer, NJ (US); Joyce Bianco, Woodbury, NJ (US); Barry Butler, Sewell, NJ (US); Harley Mattheis, Verona, NJ (US)

Correspondence Address: Hollstein Keating Cattell Johnson & Goldstein P.C;Willow Ridge Executive Office Park, Suite 301, 750 Route 73 South, Marlton, NJ, 08053, US

(21) Appl. No.: 10/669,491

(22) Filed: Sep. 24, 2003

(51) Int. Cl. A61G 9/00

(52) U.S. Cl. 4/450

(57) ABSTRACT

A portable, self-cleaning bodily receptacle consists of a fluidtight reservoir container forming an enclosed open space. Inset within the container is a toilet bowl element. The container has a fill opening and fill cap. Water or waste cleaning fluid or a combination of both is poured into the container through the fill cap, so that it fills the container reservoir around the underside and sides of the toilet bowl element. An enclosed, battery operated waterproof pump is positioned within the container and a directing hose extends from the pump, through the container space and outside the container to the toilet bowl element. When the toilet bowl element needs cleaning, the pump is actuated by a manual switch which pumps the waste cleaning fluid under pressure through and out the hose, where it is sprayed into the toilet bowl element for cleaning of the toilet bowl element. A discharge valve is provided at the bottom surface of the toilet bowl element for discharging the bodily waste and the cleaning fluid. In a second embodiment, bladders are located in the reservoir container for providing water or waste cleaning fluid under pressure to the toilet bowl element. In another embodiment, this pressurized bladder system is used in a bedpan receptacle.

### BACKGROUND OF THE INVENTION

Portable bodily waste receptacles, such as removable toilet bowls, commodes, and bedpans used for disabled or non-ambulatory individuals or in situations in which standard toilet facilities are unavailable and a portable appliance may be necessary, are well-known. Of these type commodes, few have the capability for self-cleaning and, while there are a variety of devices which purport to clean portable toilet bowls and commodes, for the most part these are generally not particularly effective and usually complicated in construction and operation and certainly are not readily portable. For instance, U.S. Pat. No. 5,907,874 discloses a rather cumbersome portable toilet, which must rely on hand pumping water from a stationary watercloset unit for cleaning. Similarly, the cleaning systems in U.S. Pat. Nos. 2,834,026, 3,083,375, and 3,166,767 all employ many moving parts and use water from fixed toilet systems, pumped through various complicated piping systems. None of these systems appear to be lightweight and readily portable, much less simple in use.

### SUMMARY OF THE INVENTION

It is thus the object of the present invention to overcome the disadvantages and limitations of prior portable self-cleaning bodily waste receptacles.

It is an object of the present invention to provide such receptacles which are lightweight and very portable.

It is a further object of the present invention to receptacles which are self-cleaning and effective in cleaning and sanitizing bodily waste in the receptacles.

It is still another object of the present invention to provide receptacles which are easy to use and easy to clean.

It is a further object of the present invention to provide receptacles which are sanitary in use.

It is still a further object of the present invention to provide receptacles which are adaptable for use over fixed toilets, commode frames, chair frames and at a variety of other facilities where such portable receptacle units would be appropriate.

It is another object of the present invention to provide receptacles which are readily and easily reusable following each use.

It is still another object of the present invention to provide receptacles which can be used with a variety of different waste cleaning fluids.

These and other objects are found in the present invention, one embodiment of which is a portable, self-cleaning bodily waste receptacle comprising a fluidtight reservoir container forming an enclosed open space. Inset within the container is a toilet bowl element, either integrally molded as part of the container or provided as a separate component sealingly placed within the opening of the container. The container has a fill opening and fill cap. Water or waste cleaning fluid or a combination of both is poured into the container through the fill cap, so that it fills the container reservoir around the underside and sides of the toilet bowl element. An enclosed, battery operated waterproof pump is positioned within the container and a directing hose extends from the pump, through the container space and outside the container to the toilet bowl element. When the toilet bowl element needs cleaning, the pump is actuated by a manual switch which pumps the waste cleaning fluid under pressure through and out the hose, where it is sprayed into the toilet bowl element. This results in the complete and effective cleaning of the toilet bowl element. A discharge valve is provided at the bottom surface of the toilet bowl element for discharging the bodily waste and the cleaning fluid after the toilet bowl element is clean. In a second embodiment of the invention, flexible containers, for instance bladders, are located in the reservoir container for providing water or waste cleaning fluid under pressure to the toilet bowl element. In another embodiment of the invention, this pressurized bladder system is used in a bedpan receptacle.

The novel features which are considered as characteristic of the invention are set forth in particular in the appended claims. The invention itself, however, as to its design, construction, and use, together with additional features and advantages thereof, are best understood upon review of the following detailed description with reference to the accompanying drawings.

### BRIEF DESCRIPTION OF THE DRAWINGS

FIG. 1 is an isometric view of the commode receptacle embodiment of the present invention.

FIG. 2 is the top view of the commode receptacle embodiment of the present invention.

FIG. 3 is a cross-sectional view of the commode receptacle embodiment of the present invention.

FIG. 4 is a side view of the commode receptacle embodiment of the present invention.

FIG. 5 is a top view of a second embodiment of the commode receptacles embodiment of the present invention.

FIG. 6 is a cross-sectional view of the second embodiment of the commode receptacle of the present invention.

FIG. 7 is a side view of the bedpan embodiment of the present invention.

FIG. 8 is a top view of the bedpan embodiment of the present invention.

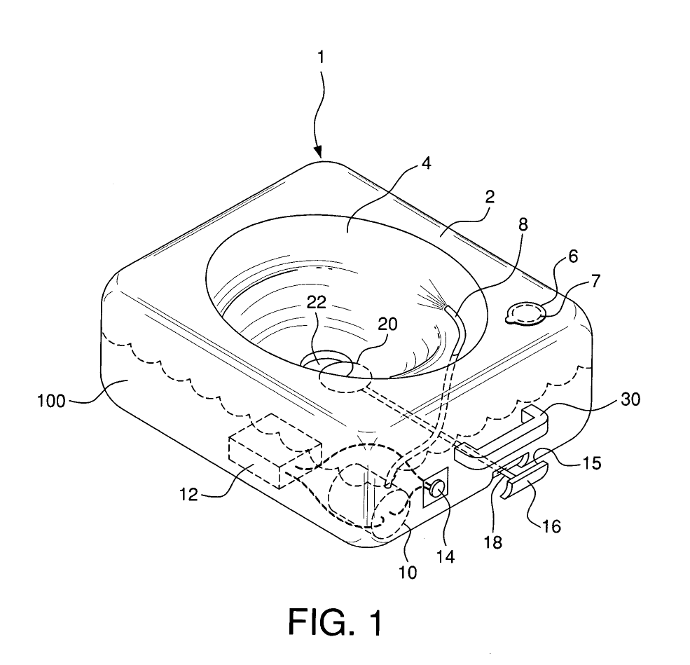

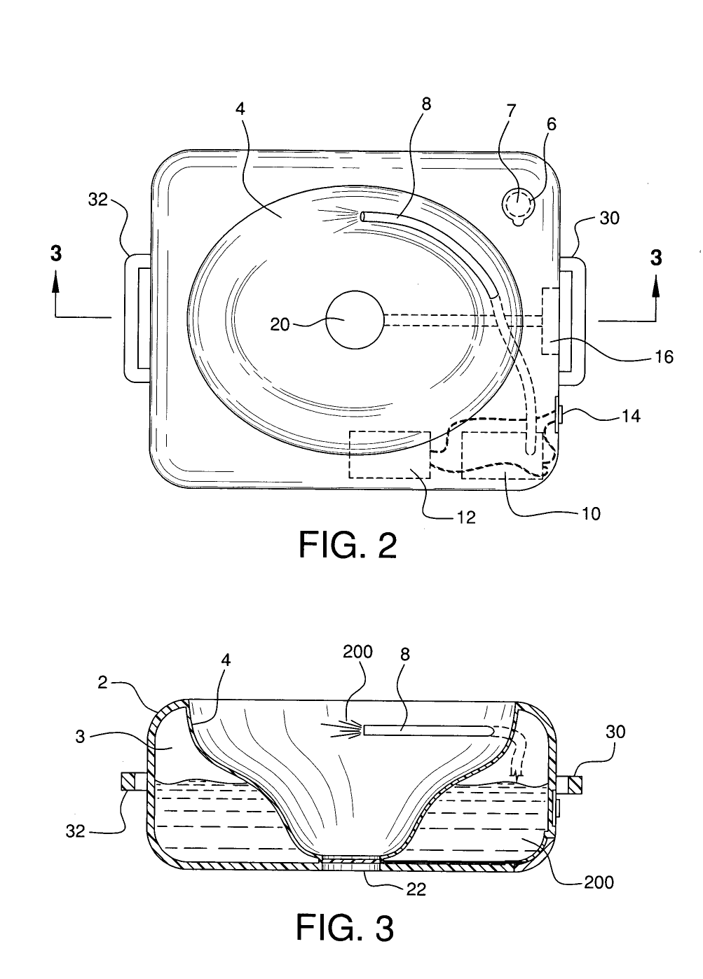

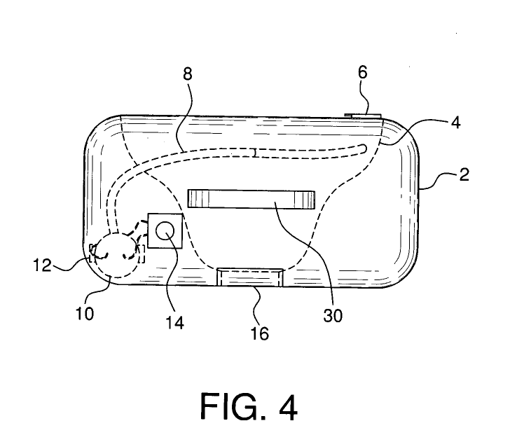

### DETAILED DESCRIPTION OF THE INVENTION

Self-cleaning, portable commode receptacle 1 comprises fluidtight reservoir container 2 into which toilet bowl element 4 is inset and positioned. Bowl element 4 can either be formed as a separate component which is placed within container 2 and sealingly mounted thereto or formed as an integral molded part of the surface of container 2. It is contemplated that both container 2 and bowl element 4 will be constructed of moldable plastic, but the scope of the invention should not be considered to be restricted by the material being used. Bowl element 4 has downwardly sloping side walls terminating at bottom opening 22.

Enclosed space 3 is formed within container 2, between its outside walls and bowl element 4. Thus container 2 comprises two separate, separated compartments, space 3 and bowl element 4. Space 3 acts as a reservoir for water, waste cleaning fluid, or a combination of water and cleaning fluid 200, which is poured into container 2 through opening 7, sealingly covered fill by fill cap 6.

Enclosed, waterproof pump 10, powered by waterproof encased batteries 12, are positioned in container 2. Manual switch 14 is provided to turn pump 10 on and off. Flexible fluid hose or tube 8 extends from pump 10, through and outside container 2, into bowl element 4. Hose 8 provides water or waste cleaning fluid from pump 10 into bowl element 4.

Slide valve 15, located on the bottom of container 2, comprises handle 16, stem 18, and disc seat 20. When valve 15 is closed, disc seat 20 covers opening 22 at the bottom surface of bowl element 4. Grasping handle 16 and pulling valve 15 outward, uncovers opening 22.

Handles 30 and 32, located on the sides of container 2, are provided to enhance the overall transport and portability of commode 1.

In operation, commode 1 is placed over a stationary toilet bowl fixture or other waste receiving container. Fill cap 7 is removed and water or other waste cleaning fluid is poured through fill opening 6 into container 2. Cleaning fluid 200 collects within container 2 and is stored there for use. When bowl element 4 requires cleaning, actuation switch 14 is depressed, thereby turning pump 10 on, which impels fluid 200, under pressure, through hose 8, spraying the pressurized fluid into and around bowl element 4, thereby cleaning the bowl element. After cleaning is completed, pump 10 is turned off by means of switch 14. Valve 15 is slid outward, causing disc seat 20 to uncover opening 22. This allows cleaning fluid 200 and the bodily waste cleaned from bowl element 4 to be discharged downwardly into the toilet bowl or other waste receiving container.

After discharge of bowl element 4, valve 15 is slid inwardly, so that disc seat 20 again covers opening 22. Water or other cleaning fluid is again poured into container 2 through opening 6, where the commode is once again available for use and subsequent cleaning.

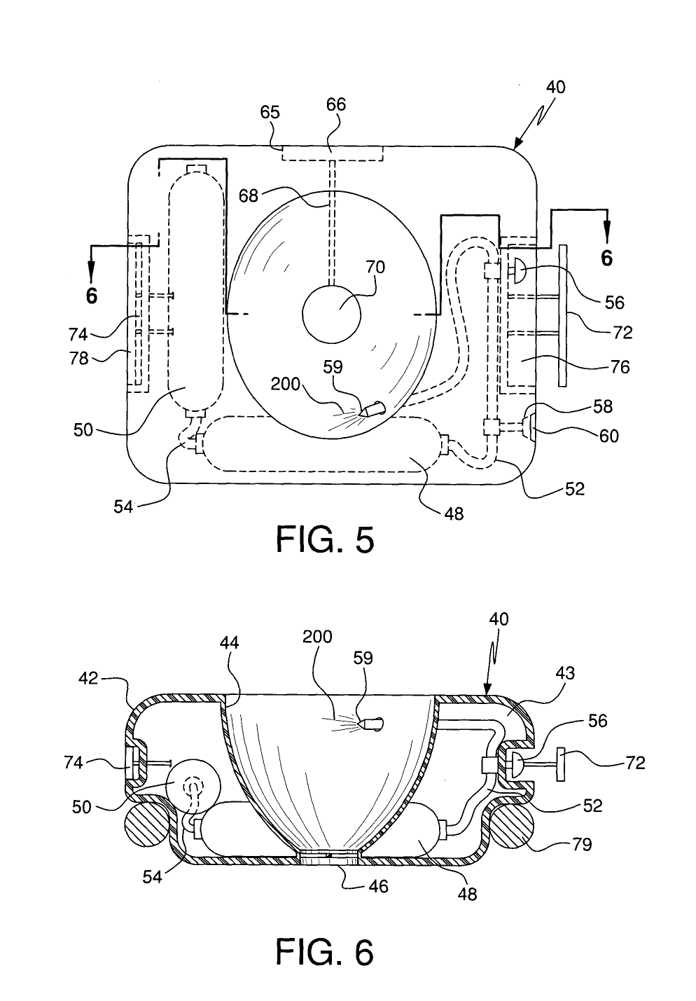

A second embodiment of the invention is shown in FIGS. 5 and 6. Commode receptacle 40 comprises fluidtight reservoir container 42 into which toilet bowl element 44 is inset and positioned. Like bowl element 4, bowl element 44 can either be formed as a separate component which is placed within container 42 and sealingly mounted thereto or formed as an integral molded part of the surface of container 42. It is contemplated that both container 42 and bowl 44 will also be constructed of moldable plastic; but again, the scope of the invention should not be considered to be restricted by the material being used. Bowl 44 has downwardly sloping side walls terminating at bottom opening 46.

Enclosed space 43 is formed within container 42, between its outside walls and bowl element 44. Thus container 42 comprises two separate, separated compartments, space 43 and bowl element 44. Located in space 43 are flexible vessel containers, e.g. bladders 48 and 50, for the storage of water or other waste cleaning fluid 200. Bladders 48 and 50 are formed of flexible material which generally expand outward as a result of the internal pressure caused by fluid within the bladders. However, the invention is not to be restricted to the type of material used or the shape of the bladders. It is also anticipated that one bladder or two or more auxiliary bladders can be positioned within space 43, depending on the volume of waste cleaning fluid which is desired.

In the embodiment shown in FIGS. 5 and 6, bladders 48 and 50 are interconnected by line 54, which can be a flexible tube, hose, or similar open line. Line 52, also a flexible tube, hose or similar open line, extends from bladder 48 through enclosed space 43 and outward through the exterior surface of bowl element 44. Spray nozzle 59 is located at the end of line 52. Push valve 56 controls the flow of water or waste cleaning fluid 200 through line 52 and into bowl element 44. Pushing valve 56 opens line 52. With valve 56 closed, the system is charged with water or other waste cleaning fluid 200 through opening 58. The fluid fills bladders 48 and 50, line 54 and line 52 downstream of closed valve 56. When totally filled and secured by fill cap 60, which closes opening 58, the system becomes pressurized with fluid.

Similar to the first herein described embodiment, slide valve 65, located on the bottom of container 42 comprises handle 66, stem 68 and disc seat 70. When valve 65 is closed, disc seat 70 covers opening 46 at the bottom surface of bowl element 44. Grasping handle 66 and pulling valve 65 outward uncovers opening 46.

Retractable handles 72 and 74, located on the sides of container 42, are provided to enhance the overall portability of commode receptacle 40. When retracted, handle 72 and 74 are housed within inset openings 76 and 78 respectively.

In operation, commode receptacle 40 is placed over a stationary toilet bowl fixture or other waste receiving container. For example, commode receptacle 40 can be configured to be placed on chair supporting rails 79, as shown in FIG. 6. As described above, when the system comprising bladders 48 and 50 and lines 52 and 54 are charged and filled with waste cleaning fluid 200, the system is pressurized with the fluid. When bowl element 44 requires cleaning, valve 56 is pushed to open line 52. Pushing valve 56 releases the pressure in the system, impelling the pressurized waste cleaning fluid 200 to flow from bladder 48, through line 52 and out nozzle 59, where the pressurized fluid is sprayed into and around bowl element 44, thereby cleaning the bowl element. Additional waste cleaning fluid flows from bladder 50.

After cleaning is completed, valve 56 is set to a closed position, stopping the flow of waste cleaning fluid 200 to bowl element 44. Valve 65 is slid outward causing disc seat 70 to uncover opening 46. This allows fluid 200 and the bodily waste cleaned from bowl element 44 to be discharged downwardly into a toilet bowl or other waste receiving container.

After discharge of bowl element 44, valve 65 is slid inward, so that disc seat 70 again covers opening 46. Water or other waste cleaning fluid 200 is again charged through opening 58 and into bladders 48 and 50, where the commode receptacle is once again available for use and subsequent cleaning.

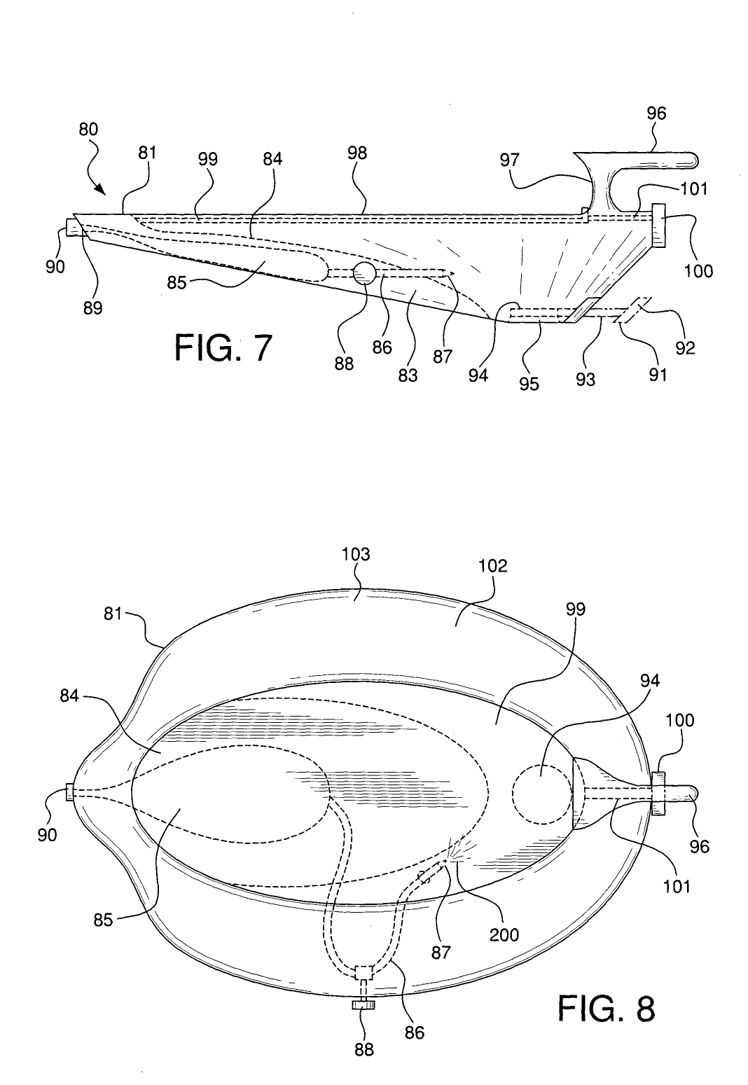

The embodiment shown in FIGS. 7 and 8 is directed to a self-cleaning, portable bedpan receptacle. Bedpan receptacle 80 comprises a unitary container 81 consisting of a bedpan shaped first compartment 82, which is configured to receive bodily waste, and, substantially underlying compartment 82, second compartment 83. Compartments 82 and 83 are separated by baffle wall 84, such that each compartment is its own separate, enclosed space. Bladder 85, for the storage of water or other waste cleaning fluid 200, is located in compartment 83. Like the bladders previously described herein, bladder 85 is formed of a flexible material which generally expands outward as a result of the internal pressure caused by fluid within the bladder.

Bladder 85 is connected to line 86, which can be a flexible tube, hose or similar open line. Spray nozzle 87 is located at the end of line 86. Push valve 88, similar to that which has previously been described, controls the flow of water or waste cleaning fluid 200 through line 86. Valve 88 extends out through the side of container 81. Pushing valve 88 opens line 86. With valve 88 closed, the system is charged with water or other waste cleaning fluid 200 through fill opening 89, at the end of bladder 85. The fluid fills bladder 85 and line 86, up to closed valve 88. When totally filled and secured by fill cap 90, which closes fill opening 89, the system becomes pressurized with fluid.

Slide valve 91, located at the bottom surface of container 81, comprises handle 92, stem 93 and disc seat 94. When valve 91 is closed, disc seat 94 covers opening 95 located at the bottom surface of container 81. Grasping handle 92 and pulling valve 91 outward uncovers opening 95.

Handle 96 extends from the top of container 81, to ensure for the portability of bedpan receptacle 80. Curved sidewall 97 of handle 96 is specifically configured to capture urine when the bedpan is in use. The sidewalls of handle 96 extend downwardly and merge into the top surface of seat section 102 of bedpan receptacle 80.

First compartment 82 has a top opening 98 to receive bodily waste. Adjacent to opening 98 is seat section 102 of bedpan receptacle 80. Seat section 102 extends outwardly, forming wing sections 103 which are configured to rest on a stationary toilet bowl fixture or other waste receiving container. Slideable cover plate 99, with handle 100 and pull rod 101, is configured to cover opening 98 when bedpan receptacle 80 is not in use or after the receptacle has been used and the bodily waste deposited therein has yet to be discharged and compartment 82 yet to be cleaned. FIGS. 7 and 8 show cover plate 99 covering top opening 98.

In operation, bedpan receptacle 80 is placed over a stationary toilet bowl fixture or other waste receiving container, as previously described with regard to the other embodiments herein. When bladder 85 is charged and filled with waste cleaning fluid 200, the system is pressurized with fluid. When compartment 82 requires cleaning, cover plate 99 is slid over top opening 98, to enclose compartment 82. Valve 88 is pushed to open line 86. Pushing valve 88 releases the pressure in the system, which causes waste cleaning fluid 200 to be impelled from bladder 85, through line 86 and out nozzle 87, where the pressurized fluid is sprayed into and around compartment 82, thereby cleaning the compartment.

After cleaning is completed, valve 88 is set to a closed position, stopping the flow of waste cleaning fluid 200 to compartment 82. Valve 91 is slid outward, causing disc seat 94 to uncover opening 95. This allows fluid 200 and the bodily waste cleaned from compartment 82 to be discharged downwardly, into a toilet bowl or other waste cleaning container.

After discharge of compartment 82, valve 91 is slid inward, so that disc seat 94 again covers opening 95. Water or other waste cleaning fluid 200 is again charged through opening 89 and into bladder 85 where bedpan receptacle 80 is once again available for use and subsequent cleaning.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A self-cleaning, portable bodily waste receptacle comprising:
(a) container means for receiving bodily waste and for receiving and storing waste cleaning fluid, said container means comprising a first compartment for receiving bodily waste and a second compartment for receiving and storing waste cleaning fluid;
(b) fill means for allowing the flow of waste cleaning fluid solely into the second compartment for storage of the fluid within the second compartment;
(c) fluid path means for directing the waste cleaning fluid from the second compartment into the first compartment; and
(d) impelling means to allow the waste cleaning fluid stored in the second compartment to travel under pressure from the second compartment, through the fluid path means, and into the first compartment.

2. The receptacle as in claim 1 wherein the first and second compartments each comprise separate, separated spaces within the container means.

3. The receptacle as in claim 1 further comprising an opening in the container means.

4. The receptacle as in claim 1 further comprising discharge means for allowing removal of bodily waste and waste cleaning fluid from the container means.

5. The receptacle as in claim 4 wherein the discharge means comprises a manually operated valve.

6. The receptacle as in claim 4 wherein the discharge means is located at the bottom of the container means.

7. The receptacle as in claim 4 wherein the discharge means discharges bodily waste and waste cleaning fluid through an opening in the container means.

8. The receptacle as in claim 6 wherein the discharge means discharges bodily waste and waste cleaning fluid through an opening in the bottom of the container means.

9. The receptacle as in claim 1 wherein the fluid path means comprises a fluid hose extending from the impelling means to the first compartment.

10. The receptacle as in claim 1 wherein the fill means comprises a fill opening and fill cap on the container means.

11. The receptacle as in claim 1 further comprising means to transport the receptacle in a readily portable manner.

12. The receptacle as in claim 11 in which the means to transport the receptacle comprises at least one handle located externally of the container means.

13. The receptacle as in claim 1 wherein the impelling means is located in the second compartment of the container means.

14. The receptacle as in claim 1 wherein bladder means for storing the waste cleaning fluid is located in the container means.

15. The receptacle as in claim 14 wherein the bladder means is located in the second compartment.

16. The receptacle as in claim 14 wherein the bladder means comprises a single bladder connected to the fluid path means.

17. The receptacle as in claim 14 wherein the bladder means comprises a plurality of bladders connected to the fluid path means.

18. The receptacle as in claim 14 wherein the impelling means comprises a manually operated valve which allows pressurized waste cleaning fluid to flow from the bladder means to the first compartment.

19. The receptacle as in claim 1 wherein the impelling means comprises a pump.

20. The receptacle as in claim 1 wherein the first compartment comprises a separate toilet bowl element extending substantially within the container means.

21. The receptacle as in claim 1 wherein the second compartment comprises a bedpan bodily waste receiving chamber.

22. The receptacle as in claim 21 further comprising manually operated cover means for closing off the bodily waste receiving chamber.

23. The receptacle as in claim 22 wherein the cover means comprises a slideable cover plate.

24. A self-cleaning, portable bodily waste receptacle comprising:
(a) bowl means for receiving bodily waste;
(b) container means for receiving and storing waste cleaning fluid, said container means substantially surrounding the bowl means and forming an enclosed space into which the waste cleaning fluid is stored;
(c) fill means for allowing the flow of waste cleaning fluid into the space for storage of the fluid within the space;
(d) fluid path means for directing the waste cleaning fluid from within the space to the bowl means; and
(e) impelling means to allow the waste cleaning fluid stored in the space to travel under pressure from the container means, through the fluid path means, and into the bowl means for cleaning the bowl means.

25. The receptacle as in claim 24 further comprising an opening in the bowl means.

26. The receptacle as in claim 24 further comprising discharge means for allowing removal of bodily waste and waste cleaning fluid from the bowl means.

27. The receptacle as in claim 26 wherein the discharge means comprises a manually operated valve.

28. The receptacle as in claim 26 wherein the discharge means is located at the bottom of the bowl means.

29. The receptacle as in claim 26 wherein the discharge means discharges bodily waste and waste cleaning fluid through an opening in the bowl means.

30. The receptacle as in claim 28 wherein the discharge means discharges waste and waste cleaning fluid through an opening in the bottom of the bowl means.

31. The receptacle as in claim 24 wherein the container means comprises a fluidtight reservoir for storing the waste cleaning fluid.

32. The receptacle as in claim 31 wherein the bowl means is located and extends substantially within the reservoir.

33. The receptacle as in claim 24 wherein the impelling means comprises a pump.

34. The receptacle as in claim 24 wherein bladder means for storing the waste cleaning fluid is located in the enclosed space.

35. The receptacle as in claim 34 wherein the bladder means comprises a single bladder connected to the fluid path means.

36. The receptacle as in claim 34 wherein the bladder means comprises a plurality of bladders connected to the fluid path means.

37. The receptacle as in claim 34 wherein the impelling means comprises a manually operated valve which allows pressurized waste cleaning fluid to flow from the bladder means to the bowl means.

38. The receptacle as in claim 24 wherein the fluid path means comprises a fluid hose extending from the means to allow waste cleaning fluid to the bowl means.

39. The receptacle as in claim 24 further comprising means to transport the receptacle in a readily portable manner.

40. The receptacle as in claim 39 in which the means to transport the receptacle comprises at least one handle located externally of the container means.

41. The receptacle as in claim 24 wherein the fill means comprises a fill opening and fill cap on the container means.

42. The receptacle as in claim 24 wherein the bowl means comprises a separate toilet bowl element sealingly secured to and extending substantially within the container means.

43. The receptacle as in claim 24 wherein the bowl means comprises a toilet bowl element which is integrally formed as a part of the container means.

44. A self-cleaning portable bodily waste receptacle comprising:
(a) an enclosed fluidtight reservoir container enclosing a space, said container comprising fill means for allowing the flow of waste cleaning fluid into the space for storage of the fluid within the space;
(b) a toilet bowl element supported by the container and extending into the space of the container;
(c) fluid path means for directing waste cleaning fluid from within the space to the toilet bowl element; and
(d) impelling means to allow the waste cleaning fluid stored in the space to travel under pressure from the container, through the fluid path means, and into the toilet bowl element, for cleaning the toilet bowl element.

45. The receptacle as in claim 44 further comprising discharge means for allowing removal of bodily waste and the waste cleaning fluid from the toilet bowl element.

46. The receptacle as in claim 45 wherein the discharge means comprises a manually operated valve.

47. The receptacle as in claim 45 wherein the discharge means is located at the bottom of the toilet bowl element.

48. The receptacle as in claim 44 wherein the fluid path comprises a fluid hose extending from the space to the toilet bowl element.

49. The receptacle as in claim 44 wherein the impelling means comprises a pump.

50. The receptacle as in claim 44 further comprising means to transport the receptacle in a readily portable manner.

51. The receptacle as in claim 50 in which the means to transport the receptacle comprises at least one handle located externally of the container.

52. The receptacle as in claim 44 wherein the fill means comprises a fill opening and fill cap located on the container.

53. The receptacle as in claim 44 wherein the toilet bowl element comprises a separate component sealingly secured to and extending substantially within the container.

54. The receptacle as in claim 44 wherein the toilet bowl element is integrally formed as a part of the container.

55. The receptacle as in claim 44 further comprising an opening in the toilet bowl element.

56. The receptacle as in claim 45 wherein the discharge means discharges waste and waste cleaning fluid through an opening in the toilet bowl element.

57. The receptacle as in claim 47 wherein the discharge means discharges waste and waste cleaning fluid through an opening in the bottom of the toilet bowl element.

58. The receptacle as in claim 44 wherein bladder means for storing the waste cleaning fluid is located in the space.

59. The receptacle as in claim 58 wherein the bladder means comprises a single bladder connected to the fluid path means.

60. The receptacle as in claim 58 wherein the bladder means comprises a plurality of bladders connected to the fluid path means.

61. The receptacle as in claim 58 wherein the impelling means comprises a manually operated valve which allows pressurized waste cleaning fluid to flow from the bladder means to the toilet bowl element.

62. A self-cleaning portable bodily waste receptacle comprising:
(a) an integrally formed unitary container comprising a bedpan shaped first compartment for receiving bodily waste, said first compartment having a top opening, and a second compartment for receiving and storing waste cleaning fluid, the second compartment being formed as a substantially enclosed space substantially underlying the first compartment.
(b) fill means for allowing the flow of waste cleaning fluid solely into the second compartment for storage of the fluid whin the second compartment;
(c) fluid path means for directing waste cleaning fluid from within the second compartment into the first compartment; and
(d) impelling means to allow waste cleaning fluid to travel under pressure from the second compartment, through the fluid path means, and into the first compartment.

63. The receptacle as in claim 62 wherein the first and second compartments each comprise separate, separated spaces within the container.

64. The receptacle as in claim 62 further comprising an opening in the container.

65. The receptacle as in claim 62 further comprising discharge means for allowing removal of bodily waste and waste cleaning fluid from the container.

66. The receptacle as in claim 65 wherein the discharge means comprises a manually operated valve.

67. The receptacle as in claim 65 wherein the discharge means is located at the bottom of the container means.

68. The receptacle as in claim 65 wherein the discharge means discharges bodily waste and waste cleaning fluid through an opening in the container.

69. The receptacle as in claim 67 wherein the discharge means discharges bodily waste and waste cleaning fluid through an opening in the bottom of the container.

70. The receptacle as in claim 1 wherein the fluid path means comprises a fluid hose extending from the means to allow waste cleaning fluid to the first compartment.

71. The receptacle as in claim 62 wherein the fill means comprises a fill opening and fill cap on the container.

72. The receptacle as in claim 62 further comprising means to transport the receptacle in a readily portable manner.

73. The receptacle as in claim 72 which the means to transport the receptacle comprises at least one handle located externally of the container.

74. The receptacle as in claim 62 wherein the impelling means is located in the second compartment of the container.

75. The receptacle as in claim 62 wherein bladder means for storing the waste cleaning fluid is located in the container.

76. The receptacle as in claim 75 wherein the bladder means is located in the second compartment.

77. The receptacle as in claim 75 wherein the bladder means comprises a single bladder connected to the fluid path means.

78. The receptacle as in claim 75 wherein the impelling means comprises a manually operated valve which allows pressurized waste cleaning fluid to flow from the bladder means to the first compartment.

79. The receptacle as in claim 62 further comprising manually operated cover means for closing the top opening of the first compartment.

80. The receptacle as in claim 80 wherein the cover means comprises a slideable cover plate.

81. The method of cleaning a portable bodily waste receptacle comprising:
(a) providing an enclosed fluidtight container with a first compartment for receiving bodily waste and a second compartment for receiving and storing waste cleaning fluid and fill means for allowing the flow of waste cleaning fluid into the second compartment and for storage of the fluid within the second compartment;
(b) providing fluid path means for directing the waste cleaning fluid from the second compartment into the first compartment;
(c) providing impelling means to allow waste cleaning fluid to travel under pressure from the second compartment to the first compartment;
(d) supplying waste cleaning fluid to the second compartment;
(e) operating the impelling means to compel the fluid, under pressure, through the fluid path means;
(f) directing the waste cleaning fluid from the fluid path means into the first compartment;
(g) applying fluid pressure to the waste cleaning fluid to clean the first compartment;
(h) providing a discharge valve to vacate the first compartment;
(i) opening the discharge valve, thereby discharging bodily waste and waste cleaning fluid from the first compartment;
(i) closing the discharge valve after the first compartment is emptied of bodily waste and waste cleaning fluid; and
(k) supplying additional waste cleaning fluid to the second compartment.
